(19) United States
(12) Patent Application Publication
(10) Pub. No.: US 2007/0024167 A1
(43) Pub. Date: Feb. 1, 2007

(54) Plasma display device

(76) Inventor: Yeung Ki Kim, Yongin-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/493,329

(22) Filed: Jul. 25, 2006

(30) Foreign Application Priority Data
Jul. 26, 2005 (KR) 10-2005-0067976

(51) Int. Cl. H01J 61/52

(52) U.S. Cl. 313/46

(57) ABSTRACT

A plasma display device having a chassis base made from synthetic resin is disclosed. In one embodiment, the plasma display device has air guide members integrally formed on the rear surface of the chassis base so as to control the flow of high temperature air generated by a driving circuit, thereby preventing the temperature of a certain portion of the plasma display device from increasing. According to one embodiment of the present invention, the plasma display device can redirect the flow of the air heated by the driving circuit which is mounted on the chassis base thus decreasing the temperature inside the display.

### RELATED APPLICATION

This application takes priority under 35 U.S.C. §119(a) from Korean application no. 2005-0067976, filed on Jul. 26, 2005, which is incorporated by reference in its entirety.

### BACKGROUND OF THE INVENTION

1. Field of the invention

The present invention relates to a plasma display device, and more particularly to a plasma display device, which can control the flow of air around a driving circuit portion, which is heated by the high-temperature driving circuit portion of a chassis base attached to the rear surface of a plasma display panel.

2. Description of the Prior Art

In general, a plasma display device refers to a flat display device which uses a plasma display panel to display images. The plasma display device includes two substrates having discharging electrodes on opposing faces thereof respectively, and discharging gases injected into defined and dosed discharging spaces between the substrates. When a predetermined amount of electricity is applied to the discharging electrodes, ultra-violet radiation is generated in the discharging spaces and excites a fluorescent substance layer so that the fluorescent substance emits light. Thus, the plasma display device can display images using the light emitted from the fluorescent substance.

The plasma display device includes a plasma display panel, a chassis base, a driving circuit portion, and various additional units which are mounted between front and rear cases assembled with each other.

The chassis base plays the role of supporting the plasma display panel and the driving circuit portion for operating the plasma display panel.

The plasma display panel includes a heat discharging sheet on the rear surface thereof so as to rapidly transfer heat generated from the plasma display panel to the chassis base. That is, the heat discharging sheet transfers heat energy generated from the plasma display panel in a conductive or convectional manner.

In the plasma display device, the heat is generated not only by the plasma display panel but also by the driving circuit portion mounted on the rear surface of the chassis base in the plasma display device, so it becomes an important subject to prevent the overall temperature of the plasma display device from increasing due to the heat generated from the driving circuit portion.

The heat generated from the driving circuit portion is transferred to an upper portion of the driving circuit portion according to a natural convection characteristic.

The conventional plasma display device can discharge hot air, which is heated by the high temperature heat generated from the driving circuit portion, from the plasma display device, the temperature increases at a certain portion of the plasma display device which corresponds to the driving circuit portion, thereby potentially causing an accident and degrading a consumer's satisfaction.

### SUMMARY OF THE INVENTION

One aspect of the present invention provides a plasma display device which can control a flow of high temperature air generated in the plasma display device, thereby preventing the temperature of a certain portion from increasing.

Another aspect of the invention provides a plasma display device which comprises: i) a plasma display panel including a front panel and a rear panel, ii) a chassis base made of a synthetic resin and mounted on a rear surface of the plasma display panel, for supporting the plasma display panel, iii) a driving circuit portion including circuit boards mounted on a rear surface of the chassis base, for transferring signals to electrodes formed on the plasma display panel and iv) air guide members formed on the rear surface of the chassis base, for dispersing heat generated from the driving circuit portion.

In one embodiment, the air guide members are integrally formed of synthetic resin on the chassis base during a molding of the chassis base and have different shapes so as to control a flow of high temperature air existing around the driving circuit portion. In one embodiment, the air guide members are projected from the chassis base and have a “V” shape, or a horizontal bar shape, but of which the shape is not limited to these shapes.

In one embodiment, the air guide members include first guide members formed substantially parallel to an upper portion of the circuit boards, and second guide members formed over and substantially parallel with the first guide members so as to cover gaps between the first guide members.

Another aspect of the invention provides a plasma display device, comprising: at least one air guide member formed on a surface of a chassis base, wherein at least one integrated circuit is formed adjacent to the at least one air guide member on the surface, and wherein the at least one air guide member is configured to deflect heated air generated from the at least one integrated circuit.

### BRIEF DESCRIPTION OF THE DRAWINGS

Embodiments of the claimed invention will be described in conjunction with the accompanying drawings.

FIG. 1 is a perspective view showing a plasma display device according to one embodiment of the present invention.

FIG. 2 is a view showing an example of air guide members mounted on a chassis base of the plasma display device according to one embodiment of present invention.

FIGS. 3A through 3C are views showing other examples of air guide members formed on a chassis base of the plasma display device according to another embodiment of the present invention.

### DETAILED DESCRIPTION OF THE PREFERRED EMBODIMENTS

Hereinafter, embodiments of the present invention will be described in detail with reference to the accompanying drawings.

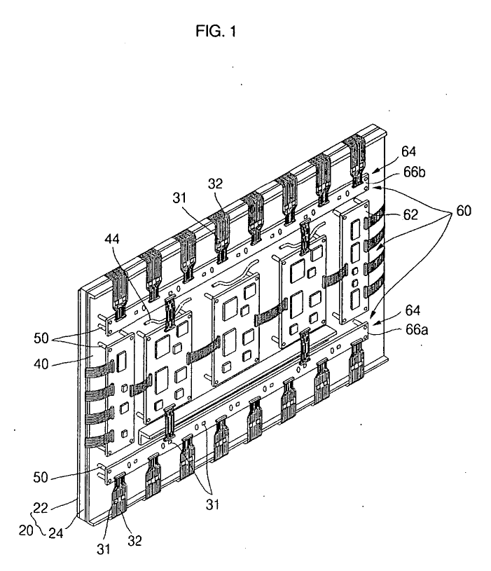

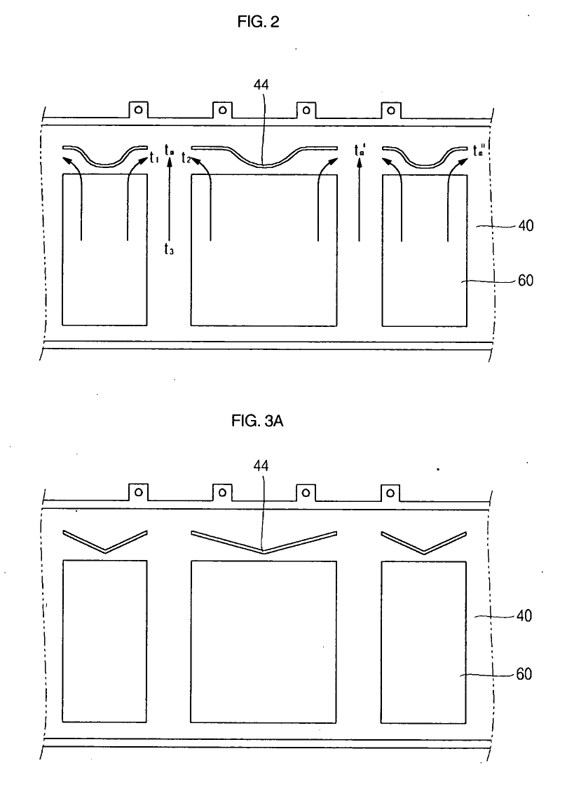

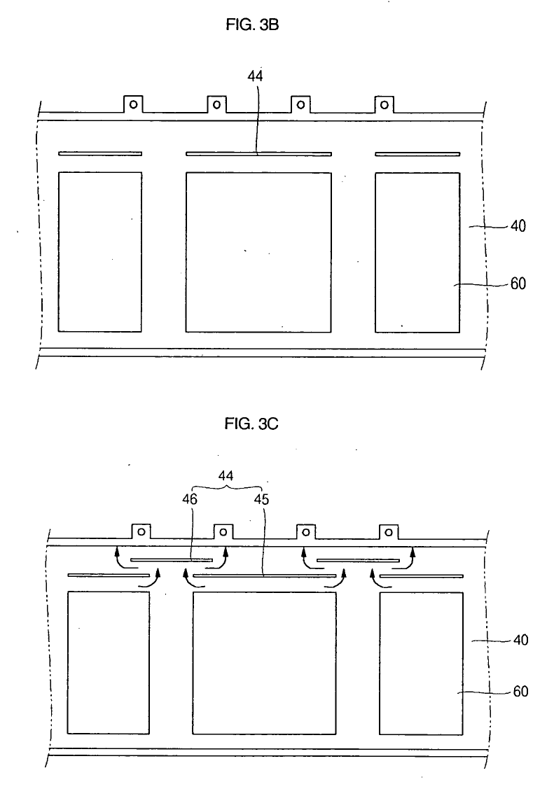

FIG. 1 is a perspective view showing a plasma display device according to one embodiment of the present invention, FIG. 2 is a view showing an example of air guide members mounted on a chassis base of the plasma display device according to one embodiment of present invention, and FIGS. 3A through 3C are views showing other examples of air guide members formed on a chassis base of the plasma display device according to another embodiment of the present invention.

As shown in FIGS. 1 and 2, the plasma display device includes a plasma display panel 20 having a front panel 22 and a rear panel 24, in which voltage applied to electrodes formed in the plasma display panel 20 causes gases filled between the front and rear panels 22 and 24 to discharge electricity and to radiate ultra-violet radiation which then the ultra-violet radiation collides against and makes a fluorescent substance layer emit light. As a result, the plasma display device can display images.

Particularly, in the plasma display panel 20, discharging cells (not shown) are defined by the front panel 22, the rear panel 24, and barriers, in which a discharge occurs. Then, the ultra-violet radiation emitted from the discharging gas excites the fluorescent substance to generate visible light, so that the plasma display device can display images.

The chassis base 40 is mounted on a surface which is opposed to the surface on which the images of the plasma display panel 20 are displayed, so as to support the plasma display panel.

In one embodiment, the plasma display panel 20 is attached to and supported by a front surface of the chassis base 40 by an attachment member such as a double-sided tape, while heat discharging sheets (not shown) are attached in regions of the chassis base 40 in which the attachment member is not attached between the plasma display device and the chassis base 40.

Signal transmitting members 32 are electrically connected to integrated circuit chips 31 respectively, so as to electrically connect the electrodes.

Further, some signal transmitting members 32 electrically connect the integrated circuit chips 21 or the plasma electrodes to address driving circuit boards 66a and 66b. In one embodiment, the signal transmitting members 32 include flexible printed circuits and tape carrier packages.

In one embodiment, the chassis base 40 has a plurality of bosses 50 press-inserted therein which are used for fixing circuit boards 62, 66a, and 66b of the driving circuit portion 60.

The driving circuit portion 60 includes electrodes (not shown) provided to the plasma display panel 20, and circuit boards 62 on which electrode switching elements are mounted so as to control electric signals applied to the electrodes. Address electrode driving portions 64 of the driving circuit portion 60 are formed at regions adjacent to upper and lower sides of the chassis base 40 and connected to address electrodes extending from upper and lower portions of the plasma display panel 20.

The address electrode driving portions 64 include a plurality of address driving circuit boards 66a and 66b. Further, the address electrode driving portions 64 may include a printed board assembly. The address driving circuit boards 66a and 66b is formed such that a plurality of electric elements are contained in a printed circuit board having a wiring pattern. The electric elements contained in the address driving circuit boards 66a and 66b may include a plurality of circuit elements such as integrated circuit chips, resistances, and condensers.

In one embodiment, air guide members 44 are integrally formed with the chassis base 40 while forming the chassis base 40 and are located in positions which are spaced from the driving circuit portion 60, so as to disperse the heat generated from the driving circuit portion 60. In another embodiment, the air guide members 44 are separately formed and coupled to the chassis base 40. This may apply to the remaining embodiments.

In one embodiment, the air guide members 44 are projected from the chassis base 40 in order to correspond to the circuit boards of the driving circuit portion 60, respectively.

The air guide members 44 may have various shapes so as to be capable of controlling the flow of the heated air around the driving circuit portion 60. For example, as shown in FIG. 2, the air guide members 44 have a round portion curved toward the driving circuit portion 60.

In another embodiment, as shown in FIG. 3A, the air guide members 44 may have a “V” shape which is positioned such that the apex of the “V” faces the corresponding circuit board of the driving circuit portion 60. In another embodiment, as shown in FIG. 3B, the air guide members 44 may have a horizontal bar shape.

The shape of the air guide members 44 need not be limited to the above-mentioned shapes. The air guide members 44 may be formed to control the flow of the air heated around the driving circuit portion 60.

As shown in FIG. 3C, the air guide member 44 may include first and second air guide members 45 and 46, in which the first air guide members 45 are formed on the chassis screen 40 and spaced from and substantially parallel with an upper portion of the driving circuit portion 60, and the second air guide members 46 are formed above the first air guide members 45 to cover gaps between the air guide members 45.

Hereinafter, the operation of a plasma display device according to one embodiment of the present invention will be described.

Referring to FIG. 2, when the plasma display panel 20 is operated, the discharging gases filled in the discharging cells discharge electricity to radiate the ultra-violet radiation. Thus, the plasma display device enables the fluorescence substrate layer to radiate visible rays by using the ultra-violet rays, and displays images.

As the driving circuit portion 60 which is mounted on the chassis base 40 operates, heat is generated from the driving circuit portion 60 and the air around the driving circuit portion 60 is heated and remains at a high temperature.

As shown in FIG. 2, the hot air around the driving circuit portion 60 flows over the upper portion of the driving circuit portion 60. That is, the air t1, and t2 heated by heat generated from the driving circuit portion 60 has a density lower than that of air around the driving circuit portion 60 and thus naturally rises. At this time, since the air guide members 44 are formed over the upper portion of the driving circuit portion 60 so as to have a round portion curved toward the driving circuit portion 60, the heated air t1 and t2 move along the round portion of the air guide members 44 and mixes with air t3 rising from a region in which the driving circuit portion 60 of the chassis base 40 is not mounted, so as to become the air tm and move upwardly in the plasma display device.

The mixed air tm is a mixture of the high temperature air t1 and t2, heated from the driving circuit portion 60, and the relatively cool air t3, which rises upwardly above the chassis base 40 and is discharged through exhaust holes (not shown) on the rear case (not shown) out of the plasma display device in a somewhat cooled state. Thus, the discharged air does not give a user an unpleasant feeling or injure a user.

In one embodiment where the air guide members 44 are integrally formed with the upper portion of the chassis base 40 to correspond with the circuit boards of the driving circuit portion 60, respectively, the air is discharged in a form of mixed air tm′, or tm″ from the plasma display device.

FIGS. 3A through 3C are views showing other examples of air guide members formed on a chassis base of the plasma display device according to another embodiment of the present invention.

FIG. 3A is a view showing the air guide members having a “V” shape and being mounted on the chassis base 40. FIG. 3B is a view showing the air guide members having a horizontal bar shape and being mounted on the chassis base 40, and FIG. 3C is a view showing the air guide members including first and second guide members 45 and 46 and being mounted on the chassis base 40.

FIGS. 3A and 3B show the air guide members integrally formed with the chassis base 40 and having its own shape. In one embodiment, as shown in FIG. 3A, the air guide members 44 have a “V” shape and allow the high temperature air heated by the driving circuit portion 60 to move toward the air guide members 44. In this embodiment, the heated air moving to the air guide members 44 flows along the V shaped air guide members 44 and is mixed with the air rising from the regions in which the driving circuit portion 60 is not mounted so as to rise to the upper portion of the chassis base 40.

Then, the air rising to the upper portion of the chassis base 40 is discharged through the exhaust holes (not shown) of the rear case (not shown) joined to the rear surface of the chassis base 40 in a relatively cool state. Thus, even though the user contacts the air, the air does not give the user an unpleasant feeling or cause an accident.

In one embodiment, the air guide members 44 shown in FIG. 3B are integrally formed with the chassis base 40 and are substantially parallel with the upper portion of the driving circuit portion 60, which cause the high temperature air heated by the driving circuit portion 60 to mix with the air flowing in the regions in which the driving circuit portion 60 is not arranged. Then, the mixed air moves toward the upper portion of the chassis base 40 and is discharged through exhaust holes of the rear case.

In one embodiment, the air guide members 44 shown in FIG. 3C are integrally formed with the chassis base 40, which include first and second air guide members 45 and 46 formed substantially parallel to the upper portion of the chassis base 40 in a zigzag formation and are spaced from each other. The air guide members 44 having the first and second air guide members 45 and 46 enable the heated air from the driving circuit portion 60 to be mixed at least twice with non-heated air as shown in FIG. 3C, thereby decreasing the temperature of the air, and then the mixed air is discharged through the exhaust holes of the rear case.

As described above, the plasma display device according to embodiments of the present invention can change the flow of the air heated by the driving circuit portion which is mounted on the chassis base so as to decrease the temperature of the air inside, and discharge the relatively low temperature air through the rear case, resulting in an increase in a user's sense of satisfaction.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A plasma display device, comprising:
a plasma display panel;
a chassis base made of a synthetic resin, wherein the chassis base includes first and second surfaces opposing each other, and wherein the first surface of the chassis base is configured to support the plasma display panel;
a driving circuit portion including circuit boards mounted on the second surface of the chassis base and configured to drive the plasma display panel; and
air guide members formed on the second surface of the chassis base and configured to disperse heat generated from the driving circuit portion.

2. The plasma display device as claimed in claim 1, wherein the air guide members are integrally formed with the chassis base.

3. The plasma display device as claimed in claim 1, wherein the air guide members are placed at positions spaced away from an upper portion of the circuit boards of the driving circuit portion.

4. The plasma display device as claimed in claim 1, wherein the air guide members are spaced from and correspond to the circuit boards, respectively.

5. The plasma display device as claimed in claim 4, wherein each air guide member has a round portion curved toward the corresponding circuit board.

6. The plasma display device as claimed in claim 1, wherein the air guide members project from the second surface of the chassis base.

7. The plasma display device as claimed in claim 1, wherein the air guide members have a “V”-shape.

8. The plasma display device as claimed in claim 1, wherein the air guide members are formed substantially parallel with an upper portion of the circuit boards.

9. The plasma display device as claimed in claim 1, wherein the air guide members include first guide members formed substantially parallel with an upper portion of the circuit boards, and second guide members formed adjacent to and substantially parallel with the first guide members so as to cover gaps between the first guide members.

10. The plasma display device as claimed in claim 2, wherein the air guide members are formed when the chassis base is molded.

11. A plasma display device, comprising:
at least one air guide member formed on a surface of a chassis base, wherein at least one integrated circuit is formed adjacent to the at least one air guide member on the surface, and wherein the at least one air guide member is configured to deflect heated air generated from the at least one integrated circuit.

12. The plasma display device as claimed in claim 11, wherein the at least one air guide member is integrally formed with the chassis base.

13. The plasma display device as claimed in claim 11, wherein the at least one air guide member is separately formed and coupled to the chassis base.

14. The plasma display device as claimed in claim 11, wherein the at least one air guide member has a round portion curved toward the at least one integrated circuit.

15. The plasma display device as claimed in claim 11, wherein the at least one air guide member has a “V”-shape.

16. The plasma display device as claimed in claim 11, wherein the at least one air guide member has a horizontal bar shape.

17. The plasma display device as claimed in claim 11, wherein the at least one air guide member includes a plurality of first guide members spaced with respect to each other and a plurality of second guide members spaced with respect to each other, wherein the plurality of first guide members are adjacent to and substantially parallel with the plurality of second guide members, and wherein each of the plurality of second guide members is located so as to overlap gaps between two adjacent first guide members.
